(19) United States
(12) Patent Application Publication
(10) Pub. No.: US 2016/0365690 A1
(43) Pub. Date: Dec. 15, 2016

(54) MULTI DEVICE POWER CHARGING ASSEMBLY

(71) Applicant: Hector Ortiz, Alexandria, VA (US)

(72) Inventor: Hector Ortiz, Alexandria, VA (US)

(21) Appl. No.: 14/736,425

(22) Filed: Jun. 11, 2015

(51) Int. Cl. H01R 27/02; H01R 13/72; H01R 13/66

(52) U.S. Cl. CPC H01R 27/02; H01R 13/6691; H01R 13/72

(57) ABSTRACT

A multi device power charging assembly includes a housing having a top wall, a bottom wall and a perimeter wall being attached to and extending between the top and bottom walls. A plurality of power cords each extends outwardly of the housing. Each of the power cords has a free end positioned outside of the housing. The free ends comprise male couplers such that a plurality of male couplers is provided to each engage a female electrical coupler of a personal electrical device. The plurality of power cords includes at least four power cords. The plurality of male couplers includes male couplers having different configurations such that at least three configurations of the male couplers is provided. A power plug is electrically coupled to each of the power cord. The power plug is configured to be electrically coupled to a power source and extend outwardly of the housing.

### BACKGROUND OF THE DISCLOSURE

### Field of the Disclosure

The disclosure relates to battery charging devices and more particularly pertains to a new battery charging device for charging a plurality of electronic devices at one time and which has the ability to simultaneously charge electronic devices having different configurations of female electric connection ports.

### SUMMARY OF THE DISCLOSURE

An embodiment of the disclosure meets the needs presented above by generally comprising a housing having a top wall, a bottom wall and a perimeter wall being attached to and extending between the top and bottom walls. A plurality of power cords each extends outwardly of the housing. Each of the power cords has a free end positioned outside of the housing. The free ends comprise male couplers such that a plurality of male couplers is provided each configured to engage a female electrical coupler of a personal electrical device. The plurality of power cords includes at least four power cords. The plurality of male couplers includes male couplers having different configurations such that at least three configurations of the male couplers is provided. A power plug is electrically coupled to each of the power cord. The power plug is configured to be electrically coupled to a power source and extend outwardly of the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a multi device power charging assembly according to an embodiment of the disclosure.

FIG. 2 is a side view of an embodiment of the disclosure.

FIG. 3 is a front view of an embodiment of the disclosure.

FIG. 4 is a top view of an embodiment of the disclosure.

FIG. 5 is a schematic view of an embodiment of the disclosure.

FIG. 6 is a top perspective view of an embodiment of the disclosure.

### DESCRIPTION OF THE PREFERRED EMBODIMENT

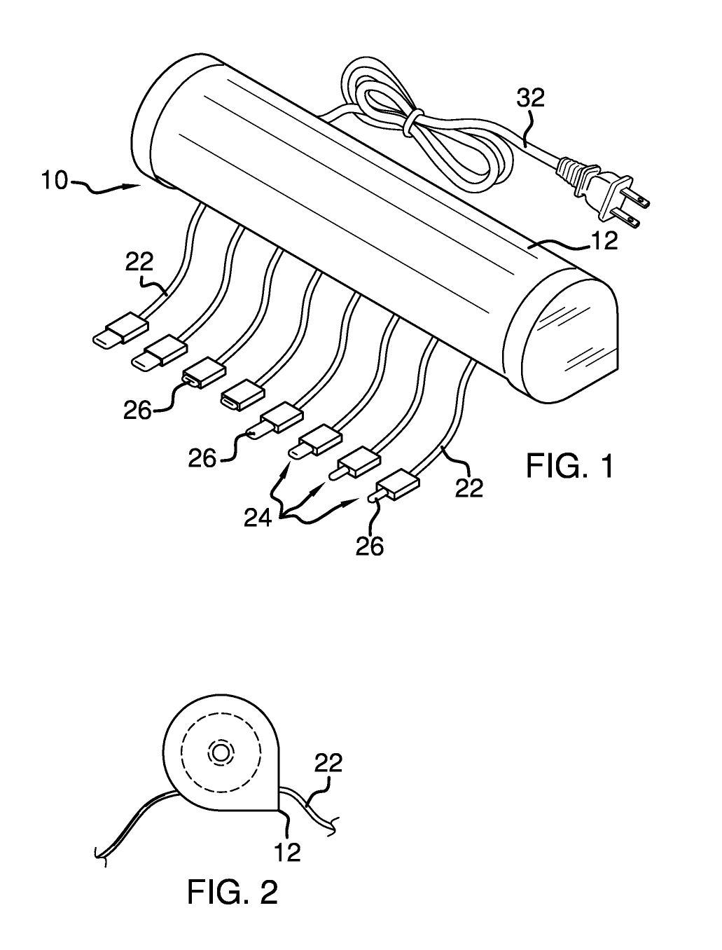

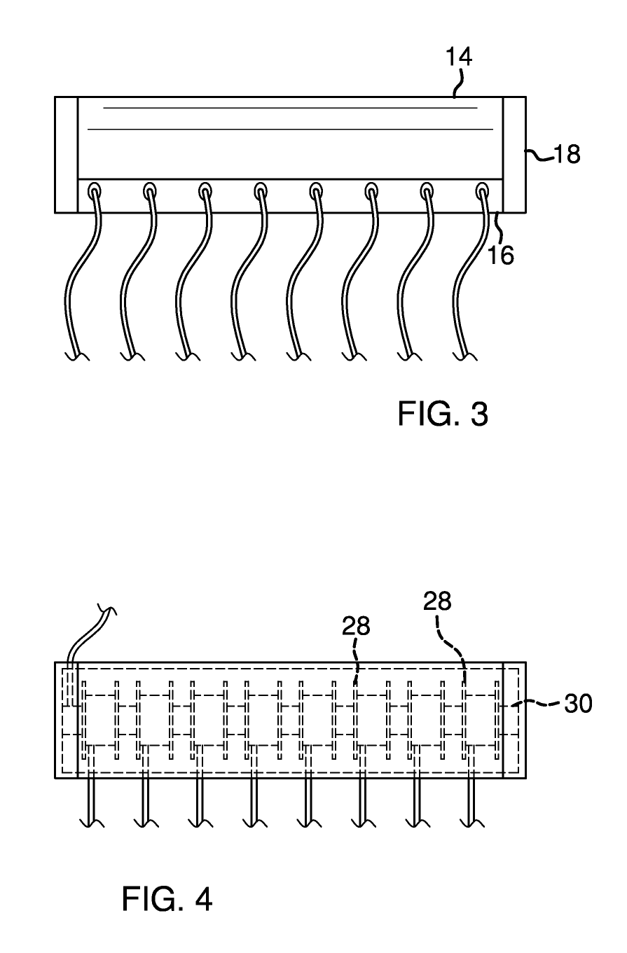

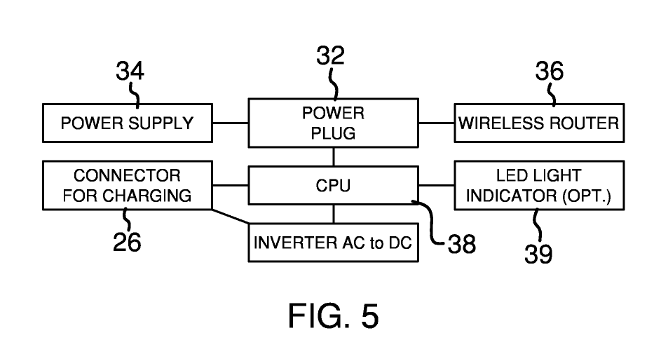

With reference now to the drawings, and in particular to FIGS. 1 through 6 thereof, a new battery charging device embodying the principles and concepts of an embodiment of the disclosure and generally designated by the reference numeral 10 will be described.

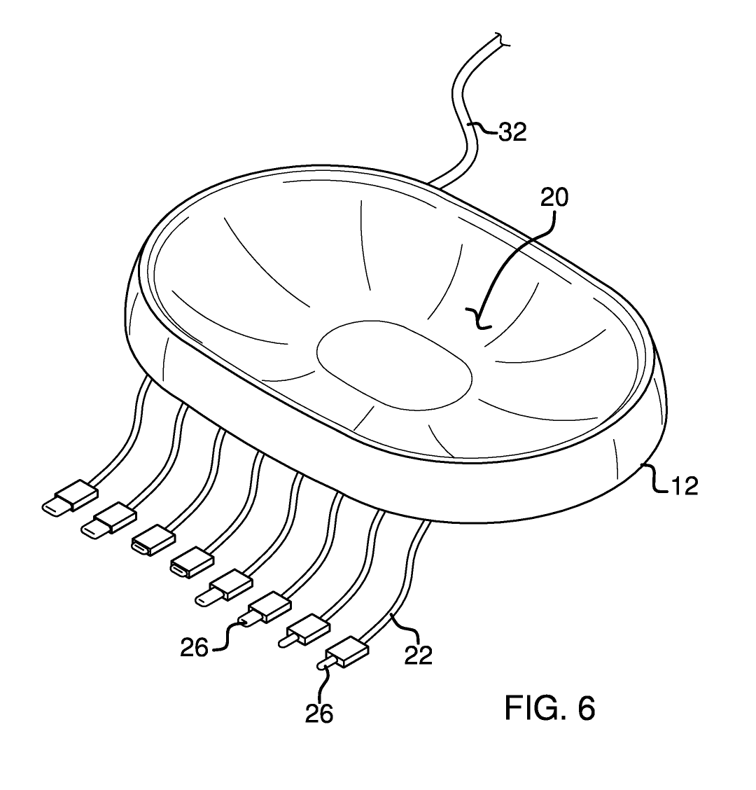

As best illustrated in FIGS. 1 through 6, the multi device power charging assembly 10 generally comprises a housing 12 that has a top wall 14, a bottom wall 16 and a perimeter wall 18 that is attached to and extends between the top 14 and bottom 16 walls. The housing 12 may have any conventional shape, however, as shown in FIG. 6, and embodiment of the assembly 10 may include a top wall 14 having an upper surface 20 with a concave shape to allow a user to place small personal articles such as personal electronic devices, wallets, keys and the like on top of the housing 12 for storage during usage of the assembly 10.

A plurality of power cords 22 is provided. Each of the power cords 22 extends outwardly of the housing 12 and each of the power cords 22 has a free end 24 positioned outside of the housing 12. The free ends 24 each comprises a male coupler 26 such that a plurality of male couplers 26 is provided wherein each of the male couplers 26 is configured to engage a female electrical coupler of a personal electrical device. The plurality of power cords 22 includes at least four power cords 22 through the number may include more than four and up to ten power cords. The plurality of male couplers 26 includes male couplers 26 having different configurations such that at least three configurations of the male couplers 26 is provided. The different configurations allow for usage with different devices. For example, one male coupler may comprise a conventional USB coupler, one may comprise a conventional micro-USB coupler, while others may comprise proprietary couplers such as those used with an iPhone 5 or iPhone 6. Though the types actually used are not essential to the assembly 10, it is important that a variety of different male couplers 26 are provided to ensure that the assembly 10 is useful to multiple people. Thus, the assembly 10 may be used in an area where a plurality of persons, or customers, are present such as in a café, restaurant and the like. Each of the power cords 22 has a length greater than at least 6.0 inches and may have a length greater than at least 12.0 inches.

A plurality of spools 28 is mounted within the housing 12. The spools 28 may each be mounted on a single spindle 30. Each of the spools 28 is rotatable within the housing 12 and each is biased in a first direction within the housing 12. This may be accomplished in any conventional manner. Each of the spools 28 has one of the power cords 22 is mounted thereon. The power cords 22 are wound onto the spools 28 when the spools 28 rotate in the first direction. A power plug 32 is electrically coupled to each of the power cords 22. This may be accomplished in any conventional manner such as having each power cord 22 being coupled to leads mounted on an associated spool 28 wherein the leads are in permanent contact with contacts on the spindle 30, wherein the power plug 32 is electrically coupled to the contacts. The power plug 32 is configured to be electrically coupled to a power source 34 such as a female electric outlet. The power plug 32 extends outwardly of the housing 12.

A transceiver 36 is mounted in the housing 12 and is electrically coupled to the power plug 32. The transceiver 36 may comprise a wireless router that is configured to wirelessly communicate with electronic devices for the purpose of providing Wi-Fi connections to the internet, for instance, for the electronic devices. A control processor 38 may be electrically coupled to the transceiver 36 and male couplers 26 to monitor the power level of the electronic devices. The power levels may be indicated by light emitters 39 which may be mounted on the housing 12 adjacent to an associated one of the power cords 22.

In use, the assembly 10 is placed on a tabletop or other area where a plurality of persons may be seated or positioned. The power plug 32 is plugged into an electric socket to provide electricity to each of the male couplers 26. This will then allow the persons adjacent to the assembly 10 to plug in and electrically charge their personal electronic devices, and in particular cellular phones and tablet computers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A recharging assembly configured for supplying power to a plurality of personal electronic device, said assembly including:
a housing having a top wall, a bottom wall and a perimeter wall being attached to and extending between said top and bottom walls;
a plurality of power cords, each of said power cords extending outwardly of said housing, each of said power cords having a free end positioned outside of said housing, each of said free ends comprising a male coupler such that a plurality of male couplers is provided, each of said male couplers configured to engage a female electrical coupler of a personal electrical device, said plurality of power cords including at least four power cords, said plurality of male couplers including male couplers having different configurations such that at least three configurations of said male couplers is provided; and
a power plug being electrically coupled to each of said power cords, said power plug being configured to be electrically coupled to a power source, said power plug extending outwardly of said housing.

2. The recharging assembly according to claim 1, wherein each of said power cords has a length greater than 12.0 inches.

3. The recharging assembly according to claim 1, further including a plurality of spools being mounted within said housing, each of said spools being rotatable within said housing and being biased in a first direction within said housing, each of said spools having one of said power cords being mounted thereon, said power cords being wound onto said spools when said spools rotate in said first direction.

4. The recharging assembly according to claim 1, further including a transceiver being mounted in said housing, said transceiver being electrically coupled to said power plug, said transceiver comprising a wireless router.

5. A recharging assembly configured for supplying power to a plurality of personal electronic device, said assembly including:
a housing having a top wall, a bottom wall and a perimeter wall being attached to and extending between said top and bottom walls;
a plurality of power cords, each of said power cords extending outwardly of said housing, each of said power cords having a free end positioned outside of said housing, each of said free ends comprising a male coupler such that a plurality of male couplers is provided, each of said male couplers configured to engage a female electrical coupler of a personal electrical device, said plurality of power cords including at least four power cords, said plurality of male couplers including male couplers having different configurations such that at least three configurations of said male couplers is provided, each of said power cords having a length greater than 12.0 inches;
a plurality of spools being mounted within said housing, each of said spools being rotatable within said housing and being biased in a first direction within said housing, each of said spools having one of said power cords being mounted thereon, said power cords being wound onto said spools when said spools rotate in said first direction;
a power plug being electrically coupled to each of said power cords, said power plug being configured to be electrically coupled to a power source, said power plug extending outwardly of said housing; and
a transceiver being mounted in said housing, said transceiver being electrically coupled to said power plug, said transceiver comprising a wireless router.
